(19) United States
(12) Patent Application Publication
(10) Pub. No.: US 2014/0092311 A1
(43) Pub. Date: Apr. 3, 2014

(54) Transcribing Medium of Variant Control Signal

(71) Applicants: Mikhail Tsinberg, New York, NY (US); Ilsoo Yu, Fort Lee, NJ (US); Leon Glenn Tsinberg, Bronx, NY (US)

(72) Inventors: Mikhail Tsinberg, New York, NY (US); Ilsoo Yu, Fort Lee, NJ (US); Leon Glenn Tsinberg, Bronx, NY (US)

(21) Appl. No.: 13/630,749

(22) Filed: Sep. 28, 2012

(51) Int. Cl. H04N 5/268

(52) U.S. Cl. CPC H04N 5/268
USPC 348/705

(57) ABSTRACT

A high definition multimedia interface using a modified format switcher for controlling electronic hardware. The modified format switcher enables infrared, RS-232, TCPIP, audio, and consumer electronics control interconnection with the high definition multimedia interface.

This Patent claims the priority of U.S. Provisional Patent Application No. 61/626,361.

### STATE OF THE ART

In the present control marketplace there exists a need for driving high definition multimedia interface commensurate with other control standards. The present invention solves the problem of driving multiple control standards over a high definition multimedia interface.

### BRIEF DESCRIPTION OF THE DRAWINGS

FIG. 1: is a mechanical view of the first embodiment of the disclosed invention wherein a mechanical drawing of a high definition multimedia interface is electrically connected to a format switcher with input port.

FIG. 2: is a schematic view of the first embodiment of the disclosed invention wherein a 3.5 millimeter or seven halves millimeter mono audio phone jack is the said format switcher.

FIG. 3: is a table of the different pathways available for at least an audio video instruction to traverse alongst the high definition multimedia interface given the positions of the said format switcher.

FIG. 4: is a mechanical view of the second embodiment of the disclosed invention wherein a mechanical drawing of an high definition multimedia interface is electrically connected to a stereo format switcher with input access.

FIG. 5: is a schematic view of the second embodiment of the disclosed invention wherein a 3.5 millimeter or seven halves millimeter stereo audio phone jack is the said format switcher.

FIG. 6: is a table of the different pathways available for at least an audio video instruction to traverse alongst the high definition multimedia interface given the positions of the said stereo format switcher.

### DETAILED DESCRIPTION OF THE DRAWINGS

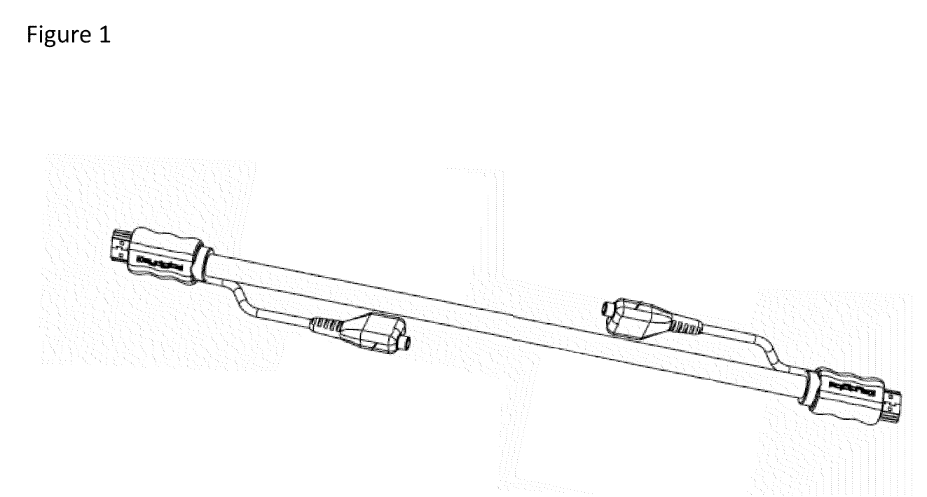

FIG. 1: is a mechanical view of the first embodiment of the disclosed invention wherein a mechanical drawing of a high definition multimedia interface is electrically connected to a format switcher with input port. The first issue to be solved is how to drive multiple control formats over a high definition multimedia interface. In the first embodiment of the disclosed invention, a single interface is connected upon a port, the port in interface port with an manual format switcher, which is connected upon a high definition multimedia interface. The result is a single high definition multimedia interface with a resulting variant control line embedded within. 10 is a high definition multimedia interface with embedded variant control line. 20 is a port the port in interface port with a manual format switcher which is connected upon a high definition multimedia interface. 30 is a port the port in interface port with a manual format switcher which is connected upon a high definition multimedia interface.

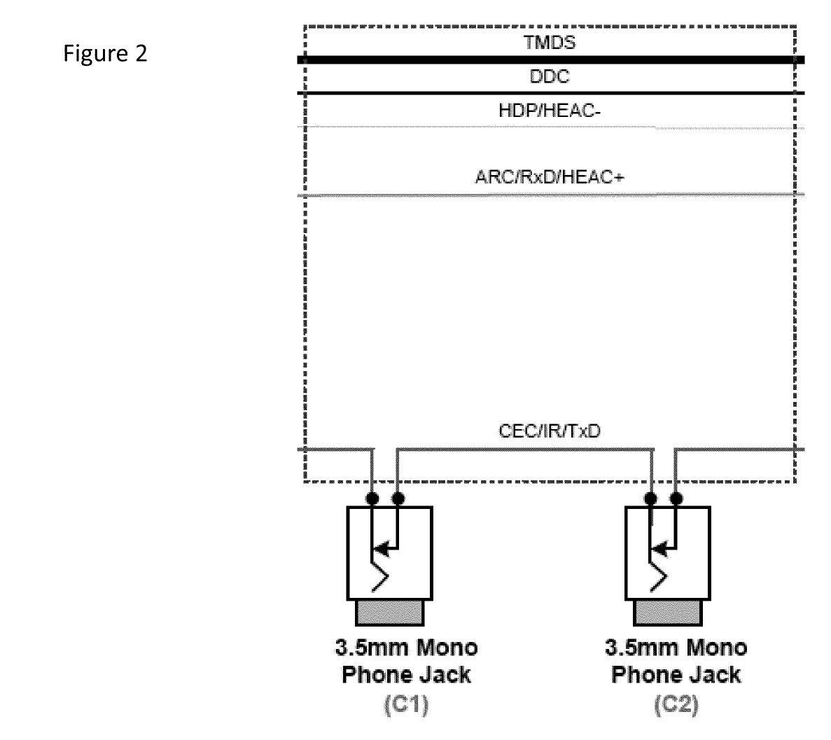

FIG. 2: is a schematic view of the first embodiment of the disclosed invention wherein a 3.5 millimeter or seven halves millimeter mono audio phone jack is the said format switcher. 40 is a 3.5 mm or seven halves millimeter phone jack interconnected upon the port is a manual switch taking the position of one (1) or off (2) depending on the connection being made upon the port. When the port is connected, the one (1) position is activated which results in a pathway, the contents of the cable being plugged into the port transporting the signal associated with the port to the high definition multimedia interface. 50 is a variant control line modified by the format switcher situated within the high definition multimedia interface. The line is modified to carry consumer electronics control, infrared, and derived signals therefrom. The signal derived signal is present as a standard interference of the control signal being pushed into the cable, the said control signal being a consumer electronic control of infrared signal, when the position of the said format switcher is in the one (1) position. The one (1) position is triggered by insertion of a medium upon the said port. 60 is a 3.5 mm or seven halves millimeter phone jack interconnected upon the port is a manual switch taking the position of on or off depending on the connection being made upon the port. When the port is connected, the on position is activated which results in a pathway, the contents of the cable being plugged into the port transporting the signal associated with the port to the high definition multimedia interface.

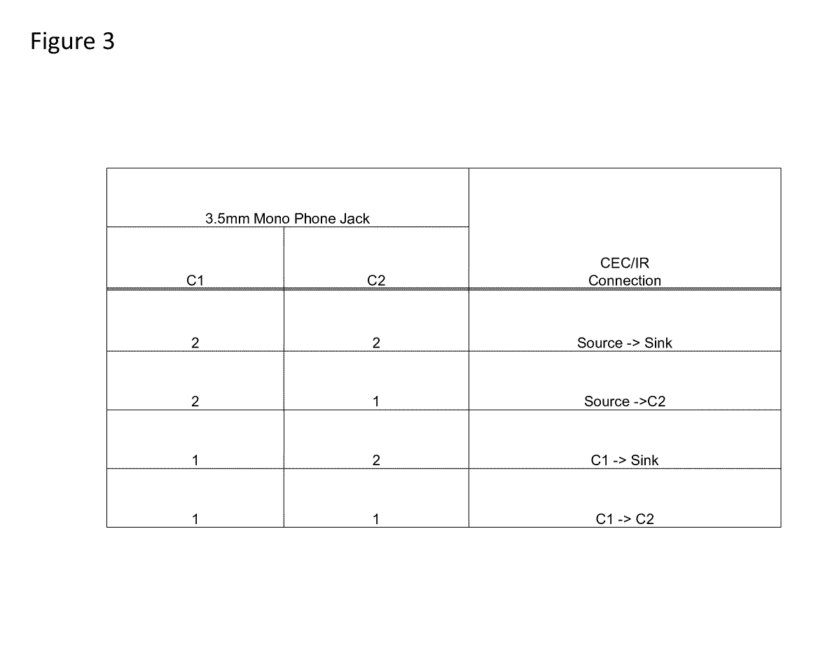

FIG. 3: 70 is a table of connections pathways taken within the high definition multimedia interface variant upon the position of the switch. The pathways associated with the positions of the switch is described in the table. The first column show the control pathway taken when both switches are in the two (2) position. When the format switcher is set into the 2 position on either side of the format switcher, integrated upon the high definition multimedia interface, the source is set to sink to the high definition multimedia interface. The second column describes when the first format switcher is set to the two (2) position and the second format switcher is set to the one (1) position. In this event, the source is set to the control format of the second format switcher. The third column describes the control pathways taken when the first format switcher is set to the one (1) position and the second format switcher is set to the two (2) position. In this event, the contents of the data traversing in the first format switcher is set to sink to the high definition multimedia interface. In the fourth column, the final command pathway functionality of the first embodiment of the disclosed invention, both format switchers are set to the one (1) position. In this event, the contents of the first, engaged, format switcher is sent directly to the port of the second, engaged, format switcher.

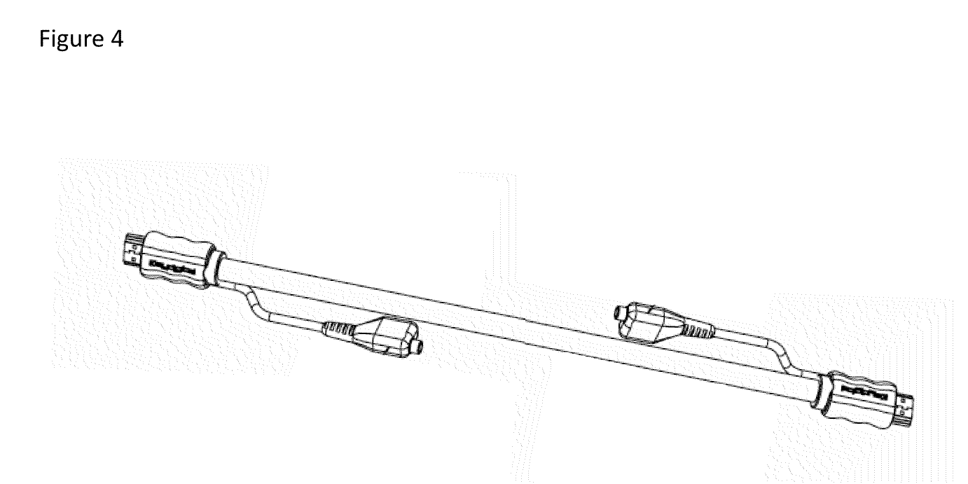

FIG. 4: is a mechanical view of the second embodiment of the disclosed invention wherein a mechanical drawing of a high definition multimedia interface is electrically connected to a stereo format switcher with input port. The first issue to be solved is how to drive multiple control formats over a high definition multimedia interface. In the second embodiment of the disclosed invention, a single interface is connected upon a port, the port in interface port with an manual stereo format switcher, which is connected upon a high definition multimedia interface. The result is a single high definition multimedia interface with a resulting variant control line embedded within. 80 is a high definition multimedia interface with embedded variant control line. 90 is a port the port an interface port with an manual stereo format switcher which is connected upon a high definition multimedia interface. 100 is a port the port in interface port with an manual stereo format switcher which is connected upon a high definition multimedia interface.

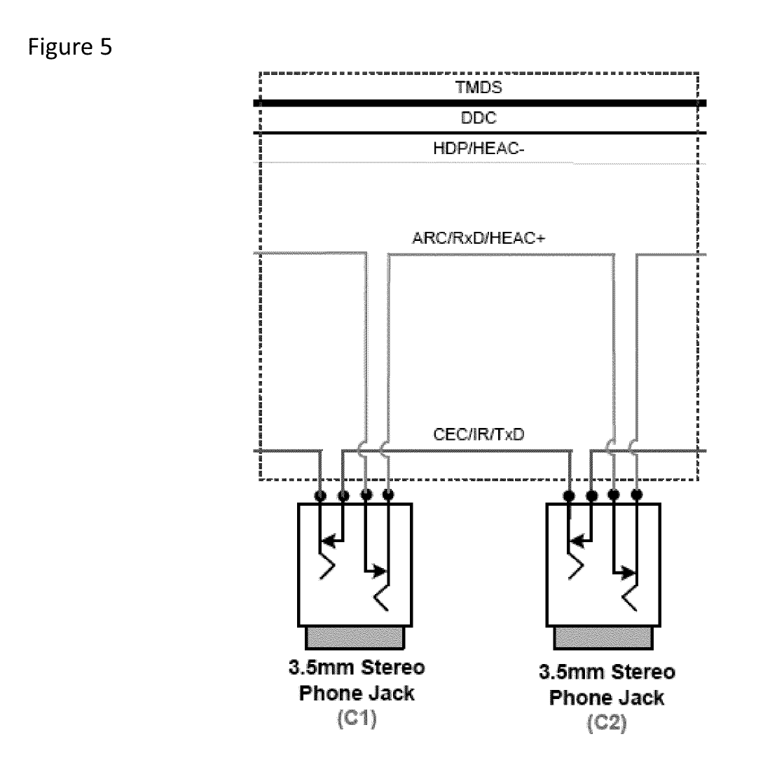

FIG. 5: is a schematic view of the second embodiment of the disclosed invention wherein a 3.5 millimeter or seven halves millimeter stereo audio phone jack is the said format switcher. 110 is a 3.5 mm or seven halves millimeter phone stereo jack interconnected upon the port is a manual switch taking the position of one (1) or two (2) depending on the connection being made upon the port. When the port is connected, the one (1) position is activated which results in a pathway, the contents of the cable being plugged into the port transporting the signal associated with the port to the high definition multimedia interface. 120 is a variant control line modified by the format switcher situated within the high definition multimedia interface. The line is modified to carry consumer electronics control, infrared, and derived transmitter signals (TxD) therefrom. The signal derived transmitter signal (TxD) is present as a standard interference of the control signal being pushed into the cable, the said control signal being a consumer electronic control of infrared signal, when the position of the said format switcher is in the one (1) position. The one (1) position is triggered by insertion of a medium upon the said port . 130 is a variant control line modified by the stereo format switcher situated within the high definition multimedia interface. The line is modified to carry audio receiver channel, high definition multimedia interface ethernet audio control (HEAC), and derived receiver signals (RxD) therefrom. The signal derived receiver signal (RxD)is present as a standard interference of the control signal being pushed into the cable, the said control signal being a consumer electronic control of infrared signal, when the position of the said format switcher is in the one (1) position. The one (1) position is triggered by insertion of a medium upon the said port. 140 is a 3.5 mm or seven halves millimeter phone stereo jack interconnected upon the port is a manual switch taking the position of one (1) or two (2) depending on the connection being made upon the port. When the port is connected, the one (1) position is activated which results in a pathway, the contents of the cable being plugged into the port transporting the signal associated with the port to the high definition multimedia interface.

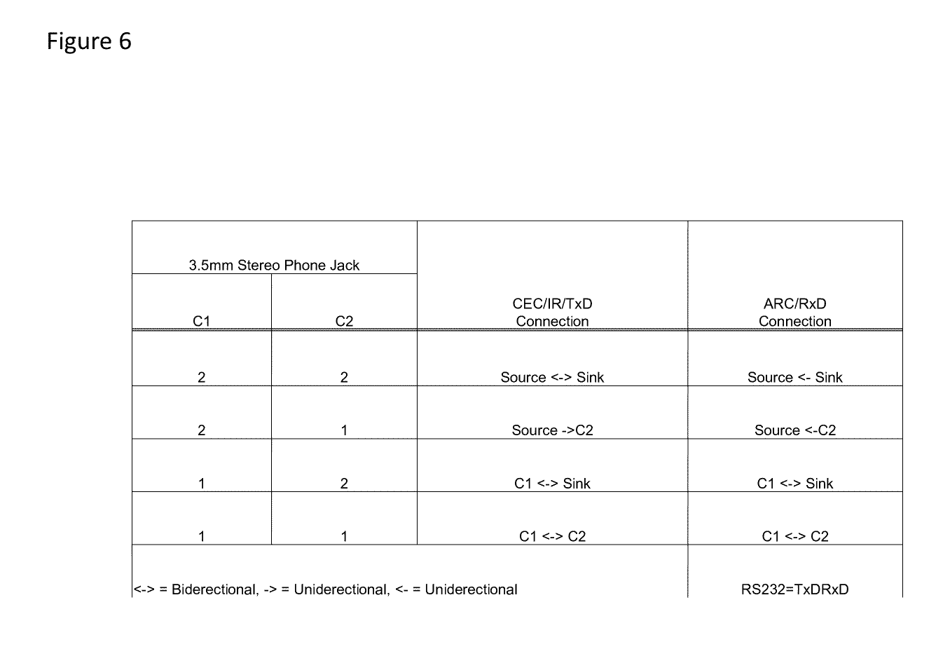

FIG. 6: 150 is a table of connections pathways taken within the high definition multimedia interface variant upon the position of the stereo switch. The pathways associated with the positions of the stereo switch is described in the table. The first column show the control pathway taken when both switches are in the two (2) position. When the format switcher is set into the 2 position on either side of the format switcher, integrated upon the high definition multimedia interface, the source is set to sink to the high definition multimedia interface, in addition to the source being set to sink to the high definition multimedia interface, the source is set to sink. The second column describes when the first format switcher is set to the two (2) position and the second format switcher is set to the one (1) position. In this event, the source is set to the control format of the second format switcher. In addition to the the source being set to the control format of the second format switcher, the TxD is transmitted from the source to the second format switcher and the RxD is transmitted from the second format switcher to the source. The third column describes the control pathways taken when the first format switcher is set to the one (1) position and the second format switcher is set to the two (2) position. In this event, the contents of the data traversing in the first format switcher is set to sink to the high definition multimedia interface. In addition to, the contents of the data traversing from the first format switcher is set to sink to the high definition multimedia interface, the TxD is transmitted from the source to the format switcher and the RxD is transmitted from the first format switcher to the source. In the fourth column, the final command pathway functionality of the first embodiment of the disclosed invention, both format switchers are set to the one (1) position. In this event, the contents of the first, engaged, format switcher is sent directly to the port of the second, engaged, format switcher. In addition to the contents of the first, engaged, format switcher being sent directly to the port of the second, engaged, format switcher, the RxD is sent along one channel of the stereo line dedicated to high definition multimedia interface ethernet audio control (HEAC) whilst the TxD is sent along the second channel of the stereo line dedicated to IRCEC. This stereo effect is exemplified in FIG. 5 reference numerals 120 and 130, respectfully.

I claim:

1. A device for controlling a plurality of components comprising:
A format switcher electrically connected to connective circuitry modified to substitute consumer electronics control video standard with infrared control standard;
A transmitting medium electrically connected to connective circuitry modified to traverse at least an audio video command packet over a consumer electronics control medium; and
A format switcher electrically connected to connective circuitry modified to substitute infrared control standard with consumer electronics control standard.

2. The format switcher of claim 1 wherein the format switcher includes a band pass filter modified to exude consumer electronics control in order to advance an infrared signal through the exemplary medium.

3. The format switcher of claim 1 wherein the format switcher includes a low pass filter modified to exude infrared signal in order to advance consumer electronics control signal through the exemplary medium.

4. The format switcher of claim 1 wherein the format switcher is a timing circuit modified to exude by means of signal timing differentials consumer electronics control in order to advance an infrared signal through the exemplary medium.

5. The transmitting medium of claim 1 wherein the at least an audio video command packet includes a consumer electronics control command packet.

6. The transmitting medium of claim 1 wherein the at least an audio video command packet includes an infrared command packet.

7. The transmitting medium of claim 1 wherein the Infrared signal originates over a mono audio cable, traversed along a consumer electronics control medium.

8. A device for controlling a plurality of components comprising:
A format multiplexer electrically connected to connective circuitry modified to hybridize consumer electronics control video standard with at least an audio video control standard into a variant audio video signal;
A transmitting medium electrically connected to connective circuitry modified to traverse at least an audio video command packet over a consumer electronics control medium; and
A format demultiplexer electrically connected to connective circuitry modified to sever at least an audio video control standard from consumer electronics control command packets.

9. The at least an audio video control standard of claim 8 includes standard AV control standards.

10. The format multiplexer of claim 8 wherein the format multiplexer is a signal format switcher modified to generate a variant signal based on baud rate derived from time.

11. The variant signal of claim 8 wherein the variant signal is modified to traverse at least a command packet of an infrared signal hybridized with a consumer electronics control signal.

12. A device for controlling a plurality of components comprising:
A central processing unit modified by software for hybridization of at least a plurality of audio video control standards;
A transmitting medium modified to traverse at least an audio video command packet of a variant signal over a consumer electronics control medium;
A central processing unit modified by software for separation of the variant signal into the at least an audio video command packet of infrared; and
A central processing unit modified by software for separation of the variant signal into the at least an audio video command packet of consumer electronics control.

13. A device for controlling a plurality of components comprising;
A consumer electronics control enabled cable modified to receive a variant signal electrically connected to at least a format switcher; and
A mono audio cable electrically connected to the said switcher modified by the said switcher to diverge at least a variant mono signal into the said consumer electronics control enabled cable.

14. The variant signal of claim 13 is a plurality of AV control standards temporally suffuse as per respective modulation.

15. The variant signal of claim 13 is a plurality of AV control standards modulated.

16. The at least a switcher of claim 13 includes an IR to variant CEC format switcher.

17. The at least a switcher of claim 13 is a mono audio to variant CEC format switcher.

18. The at least a switcher of claim 13 includes a USB to variant CEC format switcher.

19. The at least a switcher of claim 13 includes a HDMI to variant CEC format switcher.

20. The at least a switcher of claim 13 is an exemplary TCPIP to variant CEC format switcher.

21. The at least a switcher of claim 13 is an exemplary RS-232 to variant CEC format switcher.

22. The at least a switcher of claim 13 is an exemplary PCM to variant CEC format switcher.

23. The at least a switcher of claim 13 is an exemplary CV to variant CEC format switcher.

24. The at least a switcher of claim 13 is an exemplary low pass filter to variant CEC format switcher.

25. The at least a switcher of claim 13 is an exemplary band pass filter to variant CEC format switcher.

26. The at least a switcher of claim 13 is an exemplary low to high pass filter conjoined with a bidirectional adder to variant CEC format switcher.

27. The at least a switcher of claim 13 is an exemplary bidirectional frequency variable multiplexer to variant CEC format switcher.

28. The at least a switcher of claim 13 is an exemplary command platform router to variant CEC format switcher.

29. The at least a switcher of claim 13 is an exemplary format switcher to variant CEC format switcher.

30. The at least a switcher of claim 13 is an exemplary firmware to variant CEC format switcher.

31. The at least a switcher of claim 13 is an exemplary mono-directional temporal multiplexer to variant CEC temporal bidirectional format switcher.

32. The at least a switcher of claim 13 is an exemplary command packet packetizing multiplexer to variant CEC format switcher.

33. The at least a switcher of claim 13 is an exemplary format router to variant CEC format switcher.

34. The at least a switcher of claim 13 is an exemplary integrated circuit to variant CEC format switcher.

35. The at least a switcher of claim 13 is an exemplary time variable data packetizing multiplexer.

36. The at least a switcher of claim 13 is an exemplary detector of voltage emanating from an AV source automatic switcher as per the source of voltage detection.

37. The at least a switcher of claim 13 is an exemplary diverter of control data said switcher diverting said data to the CEC line of the HDMI cable.
